(19) United States
(12) Patent Application Publication
(10) Pub. No.: US 2003/0036865 A1
(43) Pub. Date: Feb. 20, 2003

(54) Methods and systems for managing resources, such as engineering test resources

(76) Inventors: ZhangQing Zhuo, Clifton Park, NY (US); Robert E. Malo, Mauldin, SC (US); William Armstrong, Simpsonville, SC (US); Gerald Hunt, Greenville, SC (US)

Correspondence Address: PERKINS COIE LLP, PATENT-SEA, P.O. BOX 1247, SEATTLE, WA, 98111-1247, US

(21) Appl. No.: 09/930,108

(22) Filed: Aug. 14, 2001

(51) Int. Cl. G06F 19/00

(52) U.S. Cl. 702/81

(57) ABSTRACT

Methods and systems for managing test resources are provided. In one embodiment, the methods and systems can be used by a field engineer located at a remote test site to request a test from a central test lab. The test requester can access a test management web site and display a web page for collecting test background information and parameters. This background information and parameters can be transmitted via a communications link to a test coordinator at the central test lab. The test coordinator can then determine the necessary test resources and prepare a cost estimate for the requested test. The test may require various resources, such as test instrumentation, data recording devices, and test personnel support. The test cost estimate and other pertinent information can then be sent back to the test requester for review and acceptance. If accepted, the test requester can then submit an order for the test.

### BACKGROUND

The following disclosure relates generally to managing resources and, more particularly, to computer-based methods and systems for scheduling engineering tests and managing resources used in such tests.

Many manufacturers of large-scale commercial and industrial equipment have their products in use all over the globe. Such manufacturers include makers of commercial airliners and makers of large land-based gas turbines for electrical power generation. Because of the operational demands often placed on such equipment, these manufacturers are frequently called upon to perform tests on the equipment to ensure proper performance or to diagnose problems encountered by customers. These tests are typically carried out by specialized teams of test personnel that travel from the manufacturer's test lab to the customer's site where the equipment is located. Sophisticated test equipment often required for such testing is typically shipped from the test lab to the customer's site for use by the test personnel.

A request for such a test will typically come from a field engineer located at the customer's site, and will generally specify the test parameters. Test personnel at the test lab will review the request and prepare a cost estimate based on the test resources required. This cost estimate is then sent back to the test requester for review and approval. If the test requester accepts the cost estimate and submits a purchase order for the test, personnel at the test lab will prepare a test schedule and allocate test resources accordingly. These resources can include various types of instrumentation and recording devices, raw materials and test personnel. Shortly before the scheduled test date, test lab personnel will identify specific pieces of test equipment for shipment to the test site. Test personnel will then travel to the site to conduct the test under the direction of the test requester.

Often, the customer cannot afford to have its equipment out of service for extended periods of time during testing. As a result, testing may be spread out over a number of days because of intermittent access to the equipment being tested. Test personnel will often leave the test site during periods when they do not have access to the equipment, and return later for testing. The test equipment, however, usually remains at the test site for the duration of the test period. When the test is complete and the test requester has confirmed that sufficient data has been acquired, the test equipment is typically repacked and shipped back to the test lab.

The entire process of coordinating and conducting a test on complex equipment at a remote location represents a substantial undertaking. The necessary tasks can include generating integrated schedules, identifying and allocating test resources, estimating costs of material and equipment, shipping and receiving test equipment, and tracking financial data. In addition, many types of sophisticated test equipment need to be continually monitored and calibrated to ensure compliance with applicable measurement standards. For manufacturers with equipment spread all over the globe who may have multiple tests in progress at any given time, providing support for all these tests can present substantial logistical problems.

Current systems for coordinating and conducting tests on complex equipment at remote locations have a number of shortcomings. For example, the test request process is typically separate from the test resource management system. As a result, it is often unknown at the time a test request is received whether a particular test resource, for example, a particular data recording device or a particular test engineer, will be available on the requested date. If it is determined that the test equipment and personnel will not be available on the requested date, then the test requester needs to be notified, another test date selected, and the whole process repeated.

Although in recent years some test labs have developed databases for scheduling and tracking test resources, these databases are nonintegrated, and thus they require a large amount of manual data entry and redundant inputs. In addition, these databases are often maintained on separate paper-based or electronic systems, such that document control is lost when paper files are not updated or electronic files are downloaded or revised on local computers without authorization. In light of these shortcomings, methods and systems for timely and efficient coordination and conduct of remote equipment tests would be desirable.

### BRIEF DESCRIPTION OF THE DRAWINGS

FIG. 1 is a diagram illustrating a display page for initiating various processes and obtaining information related to test resource management.

FIG. 2 is a diagram illustrating a display page for collecting information related to a test.

FIG. 3 is a diagram illustrating a display page for collecting information related to test parameters.

FIG. 4 is a diagram illustrating a display page for summarizing information related to a requested test.

FIG. 5 is a diagram illustrating a display page for accessing various types of test information.

FIG. 6 is a diagram illustrating a display page for collecting quantities of particular instrumentation, recording and display devices for a test.

FIG. 7 is a diagram illustrating a display page for estimating a test equipment cost.

FIG. 8 is a diagram illustrating a display page for estimating costs associated with test personnel.

FIG. 9 is a flow diagram illustrating a process for requesting a test in one embodiment.

FIG. 10 is a flow diagram illustrating a process for generating a test cost estimate in one embodiment.

FIG. 11 is a flow diagram illustrating a process for finalizing test preparations in one embodiment.

FIG. 12 is a flow diagram illustrating a routine for managing test resources in one embodiment.

FIG. 13 is a flow diagram illustrating a routine for providing test request information in one embodiment.

FIG. 14 is a flow diagram illustrating a routine for generating and providing a test cost estimate in one embodiment.

FIG. 15 is a flow diagram illustrating a routine for finalizing test preparations in one embodiment.

FIG. 16 is a flow diagram illustrating a routine for managing test resources in accordance with another embodiment.

FIG. 17 is a block diagram illustrating components of a test resource management system in one embodiment.

### DETAILED DESCRIPTION

Methods and systems are described for managing test resources. In one embodiment, the system can be used by a field engineer at a remote site to electronically request a test on a piece of equipment, such as a land-based gas turbine, located at the site. For example, the field engineer may request that the emissions output of the gas turbine be tested to ensure compliance with local standards. Alternatively, the field engineer may request that a particular part of the gas turbine, such as a rotor blade, be tested for structural integrity. As will be understood, many types of tests, including dynamic, acoustic and inspection tests, can foreseeably be requested.

The test request is received by a test coordinator located at a central test lab who, using the methods and systems described, automatically prepares a cost estimate for the requested test and determines the availability of necessary test resources. This test cost estimate and other pertinent information is then electronically sent back to the test requester for review and acceptance. If the test requester accepts the cost estimate and orders the test, then the test coordinator uses the system to automatically schedule the test, reserve the necessary test resources, and prepare the test resources for shipping to the test site. Using the methods and systems described to schedule tests and track resource allocation can avoid costly rescheduling of tests due to resource unavailability.

In one embodiment, the method is implemented on a general-purpose computer, such as a personal computer, by a user, such as a test requester, who accesses a test resource management site on a server computer. From this site, the user can select a test request display page for entering background information and parameters for the requested test. After entering this information, the user selects a submit button to bring up a summary display page containing a summary of the test requirements as entered. After reviewing the summary, the user can electronically submit a request for a test cost estimate by selecting a request cost estimate button. After submitting the cost estimate request, the user receives an electronic notification, such as an email message, containing a link to a cost estimate for the test. If, after selecting and reviewing the test cost estimate, the user elects to accept the estimate, the user can order the test by selecting an order test button.

Certain embodiments of test resource management methods and systems are described in the context of computer-executable instructions performed by a general-purpose computer, such as a personal computer. For example, in one embodiment, these computer-executable instructions are stored on a computer-readable medium, such as a floppy disk or CD-ROM. In other embodiments, these instructions are stored on a server computer system and accessed via a communications link or computer network such as an intranet or the Internet. Because the basic structures and functions related to computer-executable routines and corresponding computer implementation systems are well known, they have not been shown or described in detail here in order to avoid unnecessarily obscuring the described embodiments.

Although the following disclosure provides specific details for a thorough understanding of several embodiments of the methods and systems described, one of ordinary skill in the relevant art will understand that these embodiments may be practiced without some of these details. In other instances, it will be appreciated that the methods and systems described can include additional details without departing from the spirit or scope of the disclosed embodiments.

Although some embodiments are described in the context of an engineering hardware test, such as a functional test carried out on a large land-based gas turbine, it will be understood that the methods and systems disclosed are equally usable for much broader applications and, accordingly, can be used to manage test resources for other types of tests in addition to those described here. Further, it will be appreciated that the methods described for managing test resources can be apportioned between users and computer implementation systems in many different ways depending on the particular application. For example, in one embodiment, a large portion of the methods described can be implemented by the user while only invoking selected computer routines on an as-needed basis. Conversely, in other embodiments, the majority of the methods described can be executed on the computer implementation system while only requiring minimal inputs from the user. These and other embodiments will be understood by those of ordinary skill in the relevant art to fall within the scope of the present disclosure.

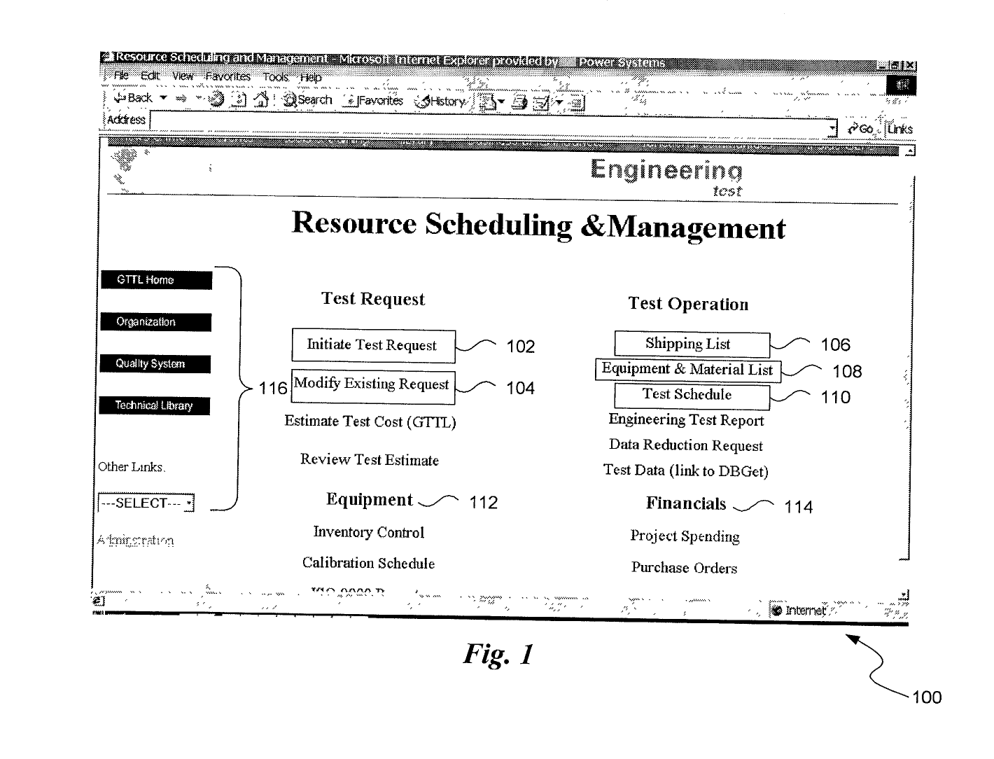

FIG. 1 is a diagram illustrating a display page 100 for initiating various processes and obtaining information related to test resource management. For example, selecting a shipping list button 106 provides the user with a display page for viewing a shipping list for a particular test. Similarly, selecting an equipment and material list button 108 provides another display page for viewing an equipment and material list for a particular test. Selecting a test schedule button 110 accordingly provides yet another display page where the user can view a test schedule for a particular test. Various equipment buttons 112 and financial buttons 114 accordingly enable the user to obtain equipment and financial information, respectively, about a particular test. Informational links 116 are also provided for obtaining information on various subjects peripherally related to test resource management.

The display page 100 also includes an initiate request button 102 and a modify request button 104. An existing test request can be modified by selecting the modify request button 104, which causes a display page to be presented for selecting an existing test request for modification. Selecting the initiate request button 102 initiates the process of requesting a new test by bringing forth a display page for entering information about the new test.

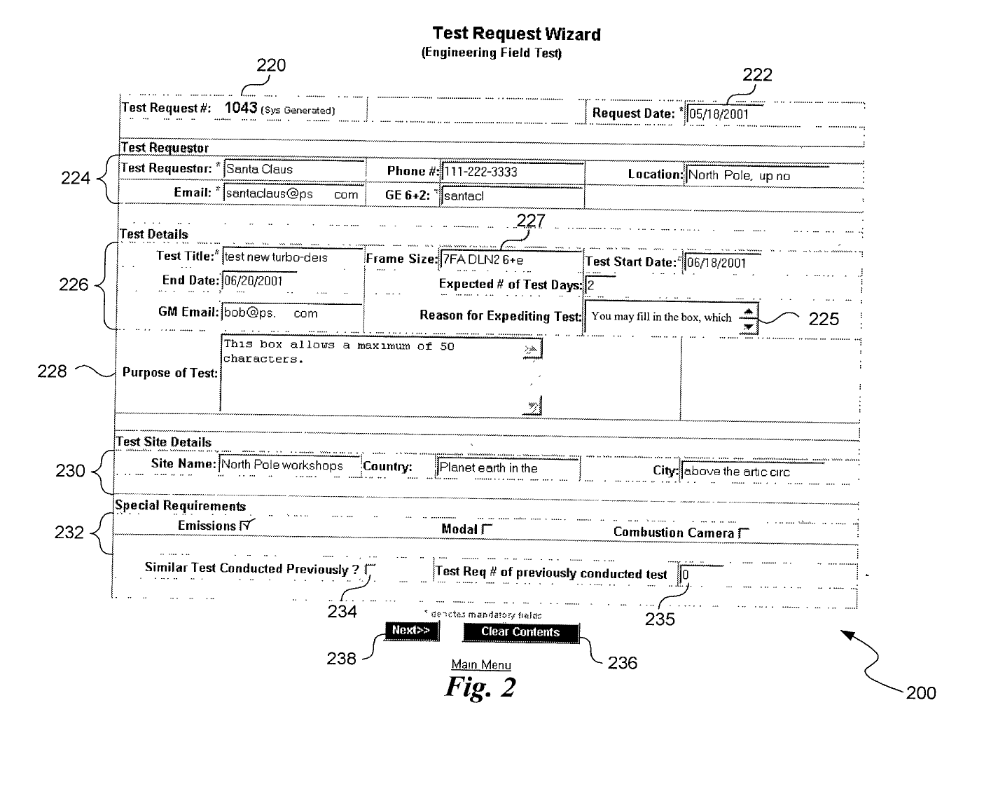

FIG. 2 is a diagram illustrating a display page 200 for collecting information related to a desired test. In one embodiment, the display page 200 includes a test request identifier 220 that is uniquely associated with a particular test request. In one aspect of this embodiment, the test request identifier 220 is automatically generated the first time the display page 200 is requested by the user. In other embodiments, the test request identifier 220 can be manually entered by the user after the user has selected a suitable number. A request date 222 can similarly be either automatically generated or manually entered by the user. In the illustrated embodiment, the display page 200 also includes a test requester portion 224, a test details portion 226, a test purpose field 228, a test site portion 230 and a special requirements portion 232.

The test requester portion 224 includes a number of fields for entering information regarding the test requester, such as the requester's name, phone number and email address. The test details portion 226 includes a number of fields for entering detailed information regarding the test, such as test start and end dates, an expected test duration and an email address for a general manager at the test site. In one aspect of this embodiment, if the test start date is within a given time period, such as within the next 30 days, the test request will be deemed an “expedited request,” and a reason for expediting the test will accordingly be required in an expediting rationale text box 225. In an equipment identification field 227, the user identifies the type of equipment to be tested. For example, in the illustrated embodiment, the test will be carried out on a 7FA first-stage turbine bucket of a land-based gas turbine.

The special requirements portion 232 includes a plurality of special requirements that can be selected by the user if applicable. For example, if the test will involve emissions testing, a modal survey, or the use of a special camera to view a combustion chamber during operation, then a corresponding special requirements box can be selected to ensure these requirements are accommodated. In one embodiment, selecting one or more of the special requirements causes a portion of the test information entered on the display page 200 to be transmitted to a selected specialist in the corresponding technical area. For example, selecting the emissions box indicates that an emissions specialist is required to review the test request. Similarly, selecting the modal box indicates that a dynamics specialist is required to review the test request and selecting the combustion camera box indicates that a camera specialist trained in viewing the combustion process in an operating turbine is required to review the test request.

A similar test box 234 can be selected by the user to indicate the existence of a prior test that is similar to the test currently being requested. If known, the test request number for the prior test can be entered in a prior test request number field 235. In one embodiment, providing a prior test request number causes one or more of the input fields on the display page 200 to be automatically populated with the corresponding information from the prior test. In this embodiment, the prepopulated information in any of the fields can then be accepted or overwritten by the user as desired. The user can clear any of the entered contents on the display page 200 by selecting a clear contents button 236. Selecting a next button 238 causes a display page to be presented for collecting information related to test parameters.

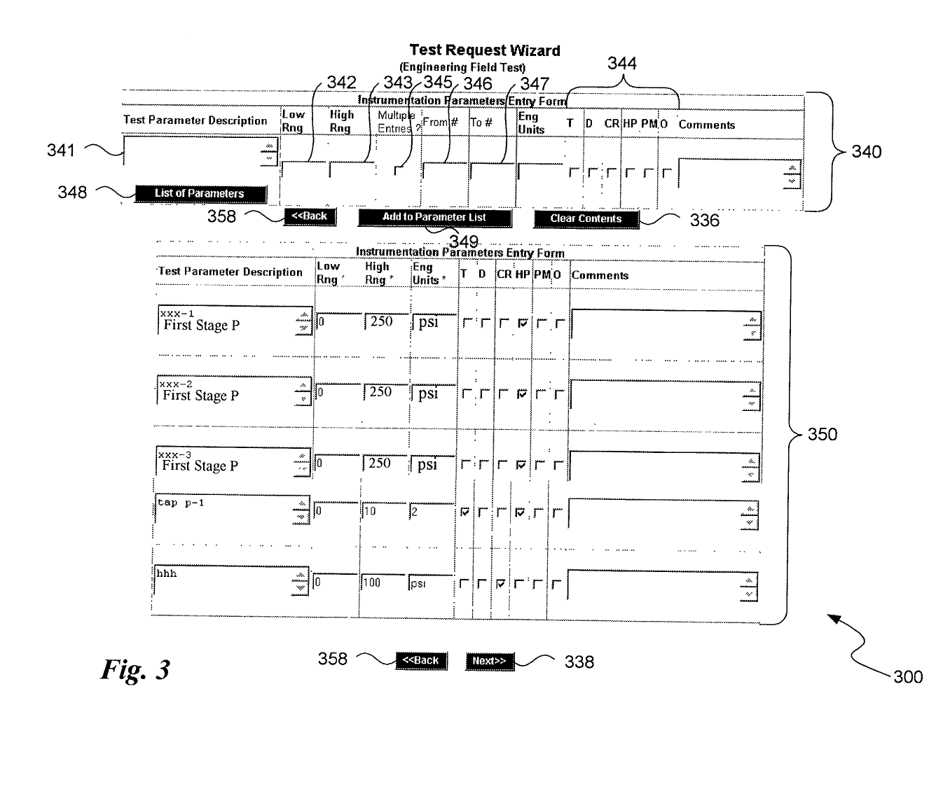

FIG. 3 is a diagram illustrating a display page 300 for collecting information related to test parameters. As used throughout this disclosure, the term “test parameter” will be understood to include particular physical measurements to be taken or specific operating conditions for the equipment during the test. Accordingly, test parameters will include physical measurement of temperatures, static and dynamic pressures, stresses, strains, flow velocities, vibrations, deflections, moisture content, etc., and operating conditions will include ambient temperature, applied loads, throttle settings, etc.

The display page 300 includes a parameter entry portion 340 and a parameter list portion 350. The parameter entry portion 340 includes a parameter description field 341 for entering a description of a desired test parameter. For example, as part of a test of a land-based gas turbine, it may be desirable to measure the vibration of a first-stage rotor blade. In this example, the test parameter description entered in the parameter description field 341 might read: “mount accelerometer to first stage rotor blade,” or simply, “measure vibration of first stage rotor blade.” Alternatively, if the user selects a standard parameter button 348, a drop-down list appears containing a selection of standard test parameters. Examples of standard test parameters may include “measure turbine inlet pressure,” “measure turbine outlet temperature,” or “measure turbine flow velocity,” to name a few. After describing a particular test parameter in the parameter description field 341, a low range for the parameter is entered in a low-range field 342 and a high range for the parameter is entered in a high-range field 343. For example, if the test parameter involves mounting an accelerometer for measuring vibration, then the low-range frequency can, for instance, be set at 10 Hz and the high-range frequency can be set at 1000 Hz.

In general, each test parameter will require a single piece of test instrumentation to measure the parameter. For example, measuring a temperature at a particular location in a turbine inlet will typically require positioning a single temperature sensor at that location. Often, however, it will be desirable to measure the same test parameter at multiple locations. For example, it may be desirable at times to measure the temperature at a plurality of locations around a turbine inlet. In this situation, the user can select a multiple entry box 345 to indicate that the test parameter will occur at more than one location or at more than one time. The number of desired locations is indicated by appropriately filling out a from field 346 and a to field 347. For example, if ten temperature measurements are desired, then the user enters a one in the from field 346 and a ten in the to field 347. This timesaving feature avoids making the user repeatedly enter the same parameter description when the same parameter is desired multiple times.

The parameter entry portion 340 also includes a plurality of device selections 344 for selecting a data collection or data display device. For example, the device selections 344 can include a tape recorder selection T, a dynamic data acquisition system selection D, a strip-chart recorder selection CR, and a nondynamic data acquisition system selection HP. The tape recording device is typically used for recording multichannel voltage signals from signal conditioners and similar devices on magnetic or digital tape. Strip-chart recording devices can record similar measurements on paper mediums for graphical illustration. The dynamic data acquisition system, in one embodiment, receives data signals and automatically processes the data into a useable form, such as a graph or plot. For example, a useable form of pressure data would include a plot of pressure in PSI as a function of time, and a useable form of strain data would include a plot of deflection in inches as a function of time. Nondynamic data acquisition systems simply record, in one embodiment, the highest static measurement of a particular parameter without respect to time. For example, if temperature was being measured, then the highest temperature achieved during the period of measurement would be recorded without regard to the change in temperature as a function of time.

The device selections 344 also include a panel meter display selection PM and an other selection O. The panel meter display selection PM allows the user to request a panel meter for digitally displaying the parameter measurement in real time. The other selection O allows the user to indicate that other nonstandard measurements, such as hand-read measurements, are required. An example of a hand-read measurement would be manually measuring the voltage across two electrical output poles during turbine operation or visually inspecting a particular part of a turbine during operation using an optical probe. Accordingly, the other selection O may indicate the use of nonstandard data recording or display devices.

The parameter entry portion 340 can include various other input fields for collecting other details about a particular test parameter. For example, an engineering units field can be included for specifying the type of engineering units desired for the parameter. A comments field can also be included for receiving additional information regarding the desired parameter from the user. Selecting a back button 358 at any time will return the user to the previous display page, and a clear contents button 336 allows the user to clear the fields in the parameter entry portion 340 to change the entries.

Once the various fields in the parameter entry portion 340 have been filled out to the user's satisfaction, the user selects an add button 349 to automatically add the parameter to the parameter list portion 350. As mentioned above, if the multiple entry box 345 is selected, then the parameter will be entered the appropriate number of times in the parameter list portion 350. For instance, referring back to the turbine example, if the first-stage pressure is to be measured in three different locations, then this parameter will occur three times in the parameter list portion 350. By repeating the process outlined above for each desired parameter, the user can generate a comprehensive parameter list for the desired test in the parameter list portion 350. Selecting a next button 338 saves the parameter information contained in the parameter list portion 350 to a suitable database and causes a display page to be presented summarizing the test information entered on the display pages 200 and 300 of FIGS. 2 and 3, respectively.

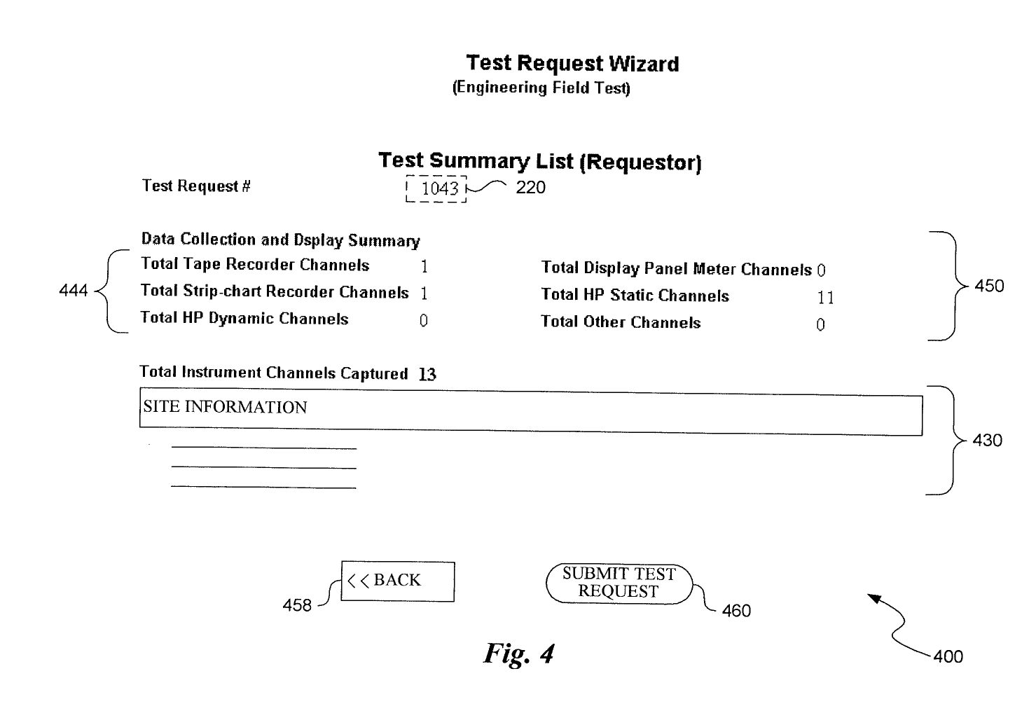

FIG. 4 is a diagram illustrating a display page 400 for summarizing information related to a requested test. The display page 400 includes a data collection and display portion 450 and a site information portion 430. The data collection and display portion 450 includes a plurality of device fields 444 for indicating the quantities of the particular test-related devices requested. In one aspect of this embodiment, these quantities can be automatically determined based on the test parameter information entered and the devices selected by the user on the display page 300 of FIG. 3. In another aspect of this embodiment, the site information portion 430 includes various details of the test site based on the site information entered by the user in the test site portion 230 of the display page 200 of FIG. 2. The unique test request identifier 220 is provided for reference as it is on many of the display pages related to a particular test request.

In one embodiment, the display page 400 gives the user an opportunity to review the details and scope of the requested test. If the details or scope differs from the user's intent or expectations, selecting a back button 458 returns the user to the previous display page so the test parameters can be revised accordingly. Alternatively, if the user reviews and accepts the test summary presented on the display page 400, selecting a submit button 460 submits a request for the test.

In one embodiment, after the user has reviewed and approved the test summary of FIG. 4, submitting a request for the test will transmit the test information to a server computer for processing. In one aspect of this embodiment, a server-side application receives the information and transmits an electronic notification, such as an email message, to another user, such as a test coordinator located at a central test lab, notifying the test coordinator that a test has been requested. In one embodiment, this email message may include a link to one or more display pages containing specific details about the requested test. Upon receiving the email message, the test coordinator can select this link to retrieve these details.

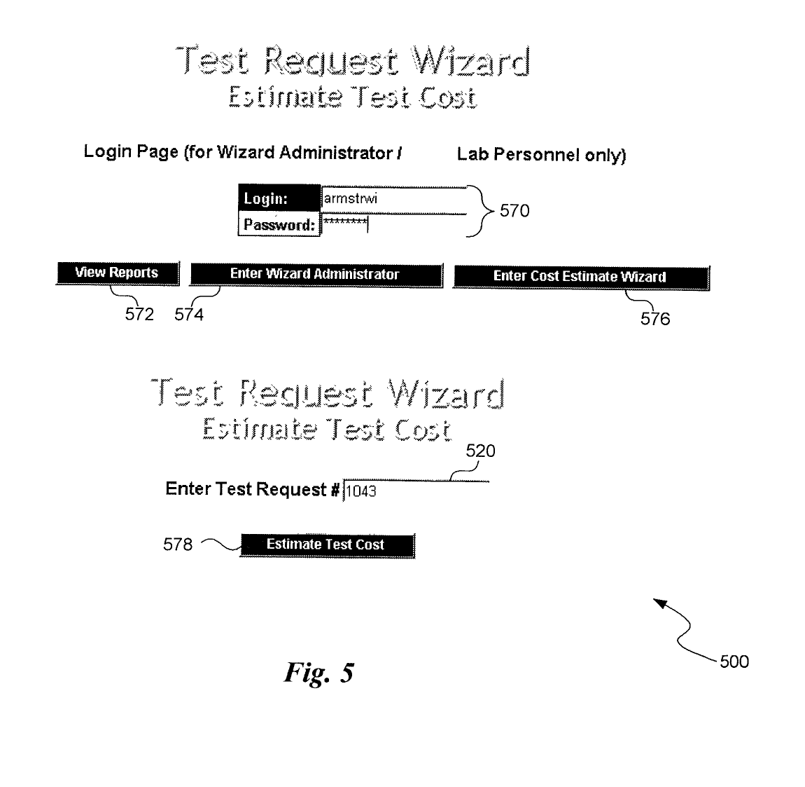

FIG. 5 is a diagram illustrating a display page 500 for accessing various types of test information. In one embodiment, the display page 500 can be presented to a test coordinator after the test coordinator has selected a corresponding link on an email message regarding a test request. A test request identifier field 520 identifies the particular test request to the test coordinator. In an alternate embodiment, this field can initially be blank and the test coordinator can enter the test request identifier of a test request of interest. Secured access to the test request information is provided by log in and password fields 570. The test coordinator is able to view test reports from prior tests by selecting a view reports button 572. Selecting an administrator button 574 allows the test coordinator to access various display pages for performing administrative tasks. These tasks may include providing other test coordinators with password access to the various test request display pages and modifying standard test parameter lists. Selecting a cost estimate button 576 allows the test coordinator to change preset costs for various types of test equipment. As will be explained in greater detail below, estimating a total test cost includes summing the costs of the various measurement and recording devices required for the test. Accordingly, selecting the cost estimate button 576 allows the test coordinator to access display pages for changing the costs associated with the various measurement and recording devices.

One purpose of the display page 500 is to allow the test coordinator to initiate the test cost estimating process by selecting an estimate test cost button 578. Selecting the estimate test cost button 578 causes one or more display pages to be presented containing details about the requested test. These display pages, for example, can be substantially similar to the display page 200 of FIG. 2 and the display page 400 of FIG. 4 described above. By reviewing the test information provided on these display pages, the test coordinator becomes familiar with the scope and details of the requested test. The test coordinator may also be presented with a test parameter display page that is substantially similar to the parameter list portion 350 on the display page 300 of FIG. 3. After reviewing the test information and parameters contained on these display pages, the test coordinator can begin estimating the various components of the total test cost by selecting an appropriate button that brings up a display page for collecting device quantities.

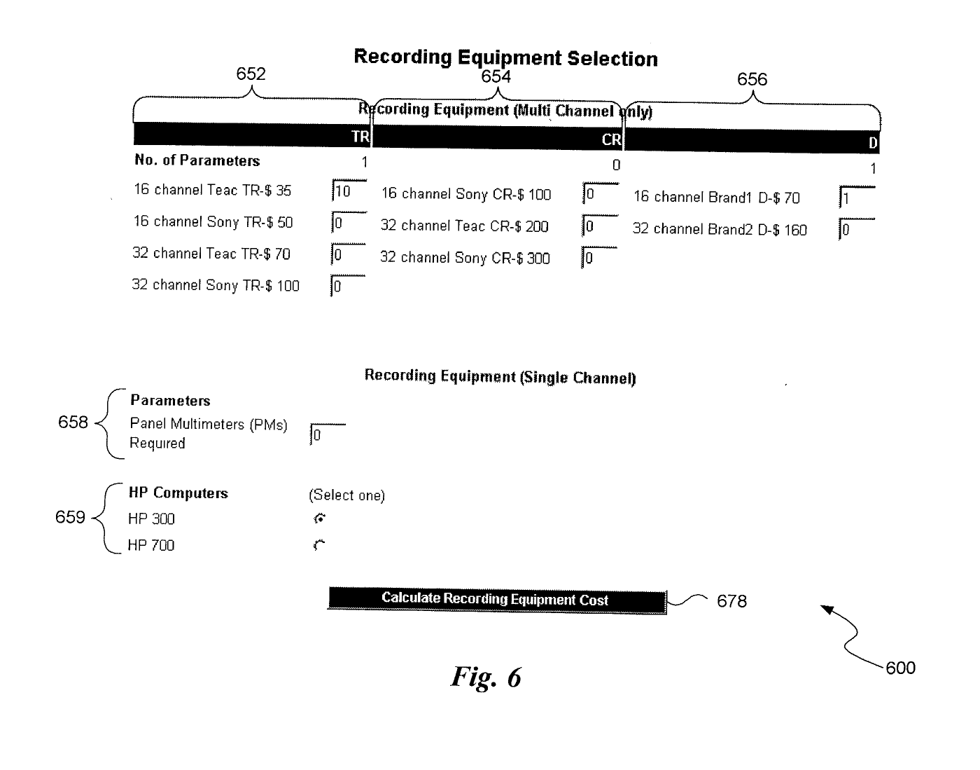

FIG. 6 is a diagram illustrating a display page 600 for selecting quantities of particular instrumentation, recording and display devices for a test. In one embodiment, the quantities specified for the various devices are automatically generated when the display page 600 is initially presented, based on the test parameters specified by the test requester on, for example, the test parameter display page 300 of FIG. 3. The test coordinator is free to accept these selections or, alternatively, to override these selections and enter other equipment selections or other quantities.

The display page 600 of the illustrated embodiment includes a tape recorder portion 652 for identifying tape recorder requirements, a strip-chart recorder portion 654 for identifying strip-chart recorder requirements, and a dynamic data acquisition system portion 656 for identifying dynamic data acquisition system requirements. A panel meter portion 658 allows the test coordinator to specify the number of panel meters required for digital display, and a static data acquisition portion 659 allows the test coordinator to define the computer system used for static data acquisition. In this embodiment, static data acquisition within the scope of foreseeable test requirements can be handled on a single computer, such as a Hewlett Packard 300 or a Hewlett Packard 700 computer. A plurality of other equipment requirements can also be specified using the display page 600, and the illustrated embodiment is but one example. After the test coordinator is satisfied that the types and quantities of equipment specified on the display page 600 meet the test requirements as specified by the test requester, the test coordinator selects a calculate cost button 678 to initiate the equipment cost estimating process.

Testing of large-scale industrial equipment, such as a test on a land-based gas turbine for electrical power generation, often involves various types of test resources. For example, such a test may require people to carry out the test, instrumentation devices for measuring different parameters such as temperature or pressure, recording devices for recording the various data measurements, and raw materials such as recording mediums and other sundry items to be expended during the test process. Accordingly, to estimate the total cost of a given test, all the various resource costs should be estimated.

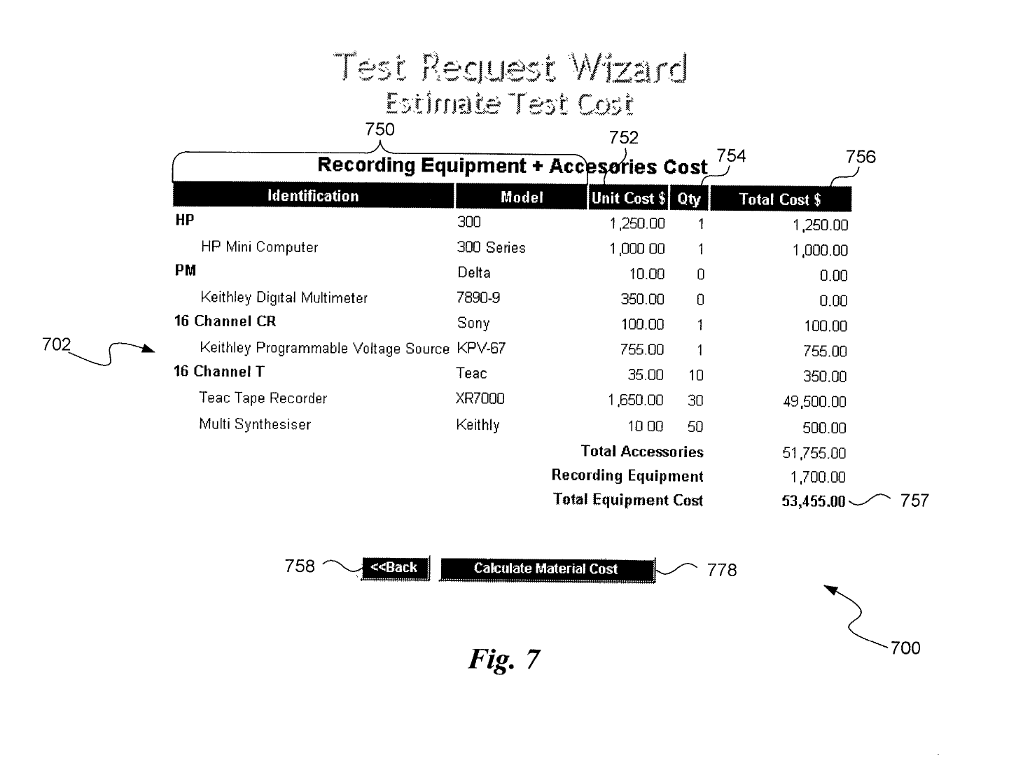

FIG. 7 is a diagram illustrating a display page 700 for estimating a test equipment cost. The display page 700 includes a cost table 702 for compiling costs associated with various types of test equipment, such as recording devices, required for a particular test. The cost table 702 includes an equipment identification portion 750 and an adjacent unit cost column 752. The equipment identification portion 750 identifies the different recording devices available. The adjacent unit cost column 752 provides the unit cost of each of the respective devices. The cost table 702 also includes a quantity column 754 and a total cost column 756. In one embodiment, the numbers in the quantity column 754 are automatically generated based on the device quantities previously entered on the display page 600 of FIG. 6. The dollar values in the total cost column 756 are accordingly generated by multiplying the quantity in the quantity column 754 by the unit cost in the unit cost column 752. Summation of the costs in the cost column 756 results in a total equipment cost 757. If, after review of the total equipment cost, the test coordinator elects to revise the equipment list, the test coordinator can do so by selecting a back button 758. Otherwise, after the equipment cost has been estimated using the display page 700, the test coordinator can proceed to estimate the cost of materials for the requested test by selecting a material cost button 778.

Various other display pages can be provided in accordance with the present disclosure for estimating the cost of other test resources. For example, a material estimating display page can be provided that lists common test materials and corresponding prices. Such a display page can also include various fields for determining the cost of shipping the test materials to the test site. In other embodiments, other display pages can be provided for calculating the cost of vendor items required for the test. Such vendor items may include special parts or fixtures manufactured solely for the requested test. In one embodiment, a display page for estimating vendor support costs can include task description fields for describing the required vendor tasks and corresponding cost fields for collecting the cost of those tasks. In yet other embodiments, other display pages can be provided for estimating costs associated with test personnel. These test personnel costs may include the hourly cost of performing the test and the travel and living expenses for the test personnel.

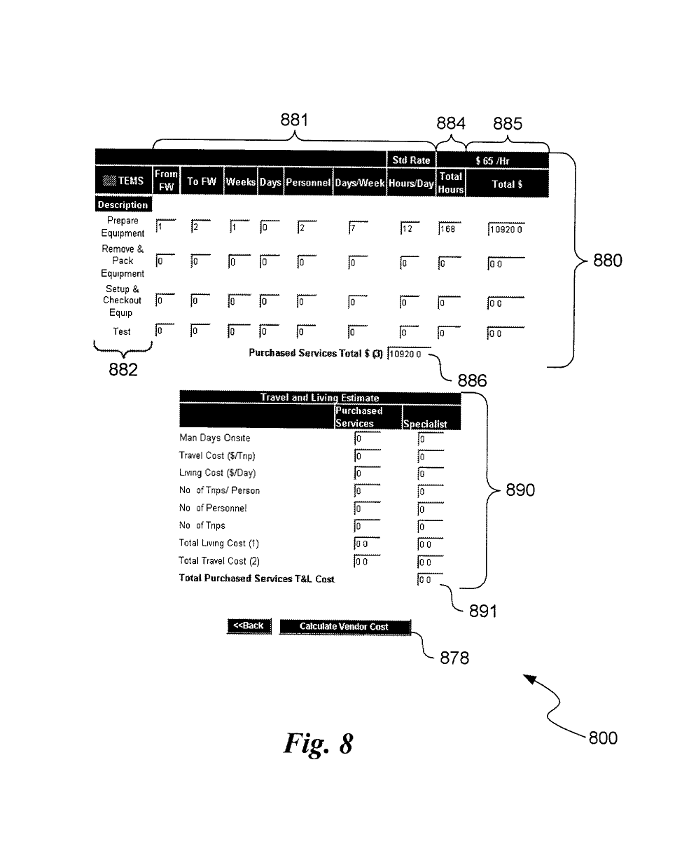

FIG. 8 is a diagram illustrating a display page 800 for estimating costs associated with test personnel. The display page 800 includes a labor hours portion 880 and a travel and living expense portion 890. The labor hours portion 880 includes a task description column 882 that describes various tasks test personnel may be engaged in during the course of preparing for and executing a given test. A number of adjacent task duration fields 881 are also provided for arriving at total hours in a total hours column 884. The test coordinator enters appropriate numbers in the task duration fields 881 and total hours and total cost are automatically generated in the total hours column 884 and a total cost column 885, respectively. For example, if test equipment preparation took two persons seven days at 12 hours per day, this would require 168 hours total. Multiplying this hours estimate times an hourly rate, such as $65 per hour, results in a total cost for test equipment preparation of $10,920, as shown in the total cost column 885. A total cost estimate for test personnel labor hours is provided in a total labor cost field 886 by summing the costs in the total cost column 885.

The travel and expense portion 890 of the display page 800 includes a list of various travel and living expenses and their corresponding costs. These costs can accordingly be combined into a total travel and living expense cost 891. After the test coordinator has accordingly estimated a total labor cost and a total travel and living expense cost, the test coordinator can select a vendor cost button 878 to initiate the vendor cost estimating process. In one embodiment, the vendor cost estimating process can accordingly use a display page similar to one or more of the cost estimating display pages described above.

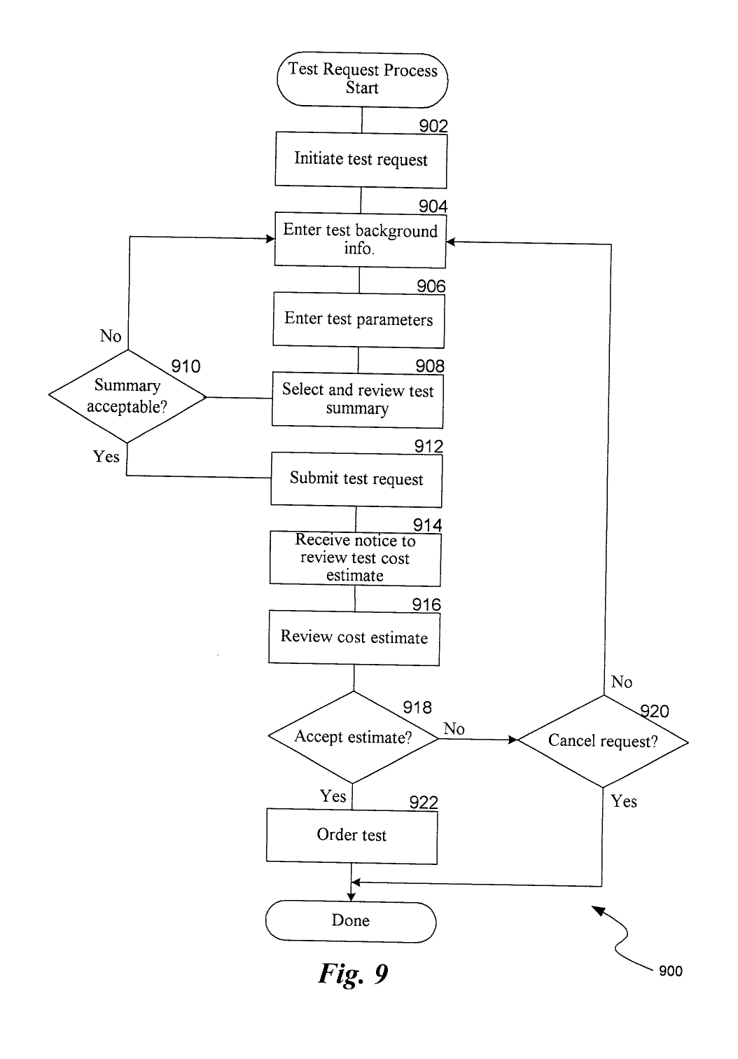

FIG. 9 is a flow diagram illustrating a process 900 for requesting a test in one embodiment. In one aspect of this embodiment, the process 900 may be used by a test requester, such as a field engineer, located at a remote site where the equipment to be tested is installed. In another aspect of this embodiment, various aspects of the process 900 can be implemented by a server computer in accordance with computer-executable instructions stored on a computer-readable medium.

In block 902, the test requester initiates a test request. In one embodiment, the test request is initiated by accessing a test resource management display page from a test resource management site on a server computer. Selecting an appropriate test request button on the test resource management display page causes other display pages to be presented for collecting detailed information about the test. Accordingly, in block 904, the test requester enters test background information into one or more of these display pages. Similarly, in block 906, the test requester enters test parameters into one or more of these display pages. In block 908, the test requester selects a test summary display page that contains a summary of the entered test background information and the entered test parameters, and reviews the summary for completeness and accuracy.

In decision block 910, the test requester determines if the test summary is complete and accurate and hence acceptable. If not, the test requester returns to one or more of the display pages previously presented for collecting test information and changes some or all of the entered information. The test requester may change any test background information or one or more of the test parameters.

If, instead, the test requester finds the test summary acceptable, then in block 912, the test requester submits the test request. In one embodiment, submitting the test request can include selecting an appropriate submit button that transmits the test details to a server computer for processing of the test request. This processing can include, in one embodiment, storing the various test details in suitable databases and sending an electronic notification, such as an email message, to a selected test coordinator notifying the test coordinator that a test has been requested. As explained above, this electronic message may include a link the test coordinator can select to access test details. In one embodiment, as will be described in greater detail below, the test coordinator can then generate a cost estimate for the test based on the accessed test details and transmit this cost estimate, via the server computer and a suitable communications link, back to the test requester for review and approval.

In block 914, the test requester receives notice that a cost estimate for the requested test has been prepared and the test requester should review the cost estimate. In one embodiment, this notice is an electronic message, such as an email message, that includes a link to the cost estimate. In block 916, the test requester selects this link and reviews the cost estimate. In decision block 918, the test requester determines if the cost estimate is acceptable. If not, in decision block 920, the test requester determines whether to cancel the test request. If the test requester elects to proceed with the test, then the test requester can return to block 904 and revise one or more of the test requirements with the intent that doing so will result in a test cost estimate that is acceptable. Conversely, if the test requester elects to cancel the test, then the test requester may so notify the test coordinator and the process 900 is complete.

Returning to decision block 918, if the test requester finds the test cost estimate acceptable, then in block 922, the test requester orders the test. In one embodiment, the test requester orders the test by selecting a corresponding order button on a test cost estimate display page. After ordering the test, the process 900 is complete.

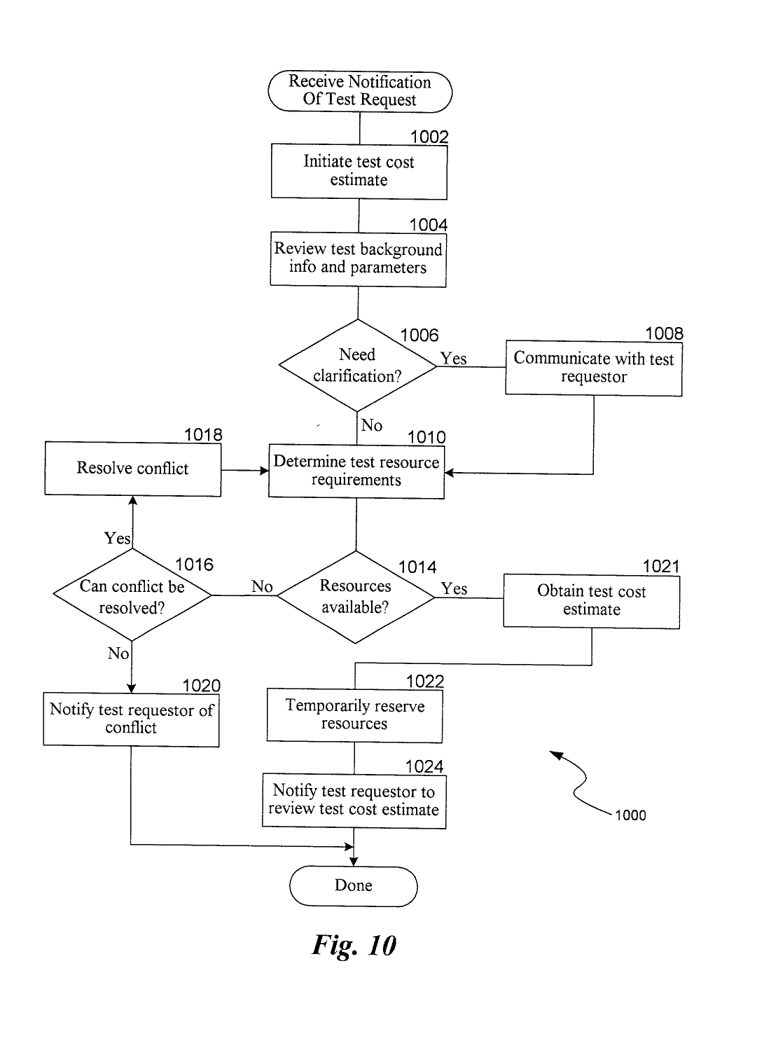

FIG. 10 is a flow diagram illustrating a process 1000 for generating a test cost estimate in one embodiment. In one aspect of this embodiment, the process 1000 can be carried out by a test coordinator after receiving an electronic notification, such as an email message, notifying the test coordinator of a test request and containing a link to a test resource management display page. Selecting the link causes the test resource management display page to be presented containing one or more links to additional information about the requested test.

In block 1002, the test coordinator selects an estimate test cost button on the test resource management display page to initiate the cost estimating process. Selecting this button causes one or more display pages containing test background information and test parameters to be presented. In block 1004, the test coordinator reviews the test background information and test parameters. In decision block 1006, the test coordinator determines if any of the test information needs clarification. If so, then in block 1008, the test coordinator contacts the test requester, such as by telephone or email, to obtain the needed clarification. If no clarification is needed, then in block 1010, the test coordinator determines what test resources are required to perform the test according to the specified parameters. In decision block 1014, the test coordinator determines if the required resources are available. If not, then in decision block 1016, the test coordinator determines if the resource conflict can be resolved. If the resource conflict cannot be resolved, then in block 1020, the test coordinator notifies the test requester of the resource conflict and the process 1000 is complete. If the test resource conflict can be resolved, then in block 1018, the test coordinator resolves the conflict and returns to block 1010 to determine if any of the new resource requirements have changed. Resolution of the resource conflict may include changing the test parameters or obtaining the unavailable resources elsewhere.

Returning to decision block 1014, if all the required resources are available, then in block 1021, the test coordinator obtains a cost estimate for the test. In one embodiment, this cost estimate can be automatically generated based on the determined resource requirements using one or more display pages at least substantially similar to those described above with reference to FIGS. 6, 7 and 8. In other embodiments, the cost estimate can be manually generated using other estimating techniques. In block 1022, the test coordinator temporarily reserves the required test resources. In this embodiment, the test coordinator temporarily reserves the required test resources for a set period of time until the test requester can confirm the test plans and submit a test order. For example, in one embodiment, the test resources can be temporarily reserved for a period of two weeks. In other embodiments for other applications, the test resources can be reserved for different time periods, or alternatively, the required test resources can be permanently reserved at this time. In block 1024, the test coordinator notifies the test requester that a test cost estimate has been prepared and the test requester should review the test cost estimate for approval. In one embodiment, this notification is an electronic notification, such as an email message, transmitted to the test requester via a server computer and a suitable communications link, such as the Internet. After the test requester has been so notified, the process 1000 is complete.

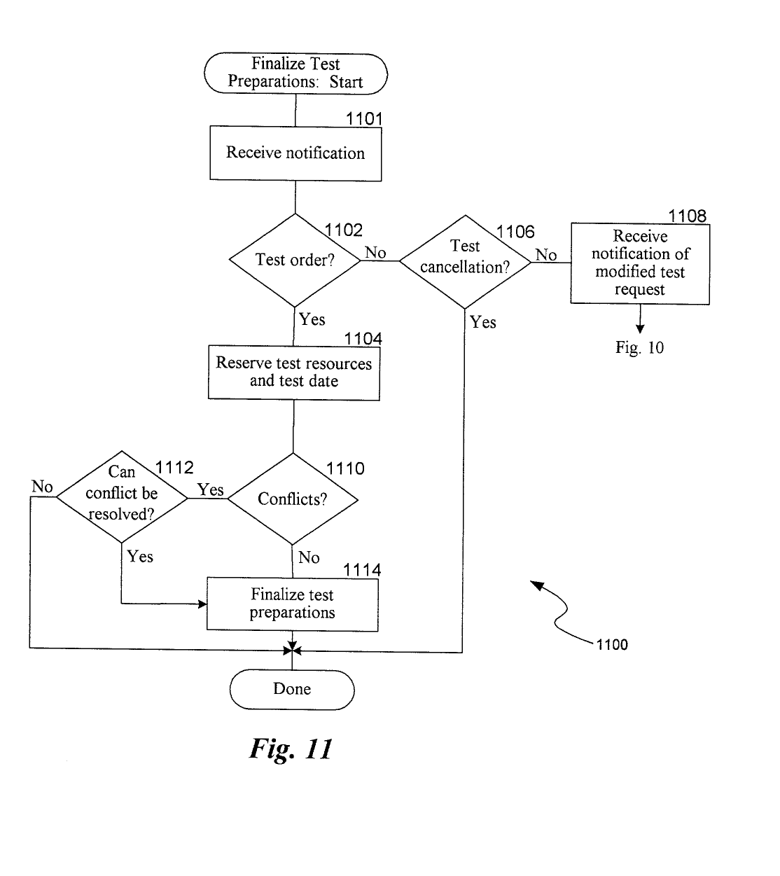

FIG. 11 is a flow diagram illustrating a process 1100 for finalizing test preparations in one embodiment. In one aspect of this embodiment, the process 1100 can be carried out by the test coordinator after receiving an order for a test, such as a purchase order, from the test requester. In another aspect of this embodiment, various aspects of the process 1100 can be implemented by a server computer in accordance with computer-executable instructions stored on a computer-readable medium.

In block 1101, the test coordinator receives an electronic notification, such as an email message, from the test requester regarding the requested test. In decision block 1102, the test coordinator determines if the test requester is ordering the test. If the test requester is not ordering the test, then in decision block 1106, the test coordinator determines if the test requester wishes to cancel the test request. If so, then the test request is cancelled and the process 1100 is complete. If the test requester does not wish to cancel the test request, then in block 1108, the test coordinator receives notification that the test requester wishes to modify the test request. After the test requester modifies the test request, the test coordinator can estimate a new test cost using a process such as that shown in FIG. 10.

Returning to decision block 1102, if the test coordinator receives an order for the test, then in block 1104, the test coordinator permanently reserves the test resources and the test date. In decision block 1110, the test coordinator determines if any conflicts exist regarding the test resources or dates. If a conflict exists, then in decision block 1112, the test coordinator attempts to resolve the conflict. If the conflict cannot be resolved, then the test coordinator notifies the test requester accordingly and the process 1100 is complete. The test requester may then elect to modify the test request in order to avoid the conflict. If the conflict can be resolved, however, or if no conflict exists, then in block 1114, the test coordinator finalizes test preparations. These preparations can include obtaining equipment lists, material lists, and shipping lists. Other preparations, such as procuring vendor-sourced items and calibrating test equipment, may also be included. After finalizing the test preparations, the process 1100 is complete.

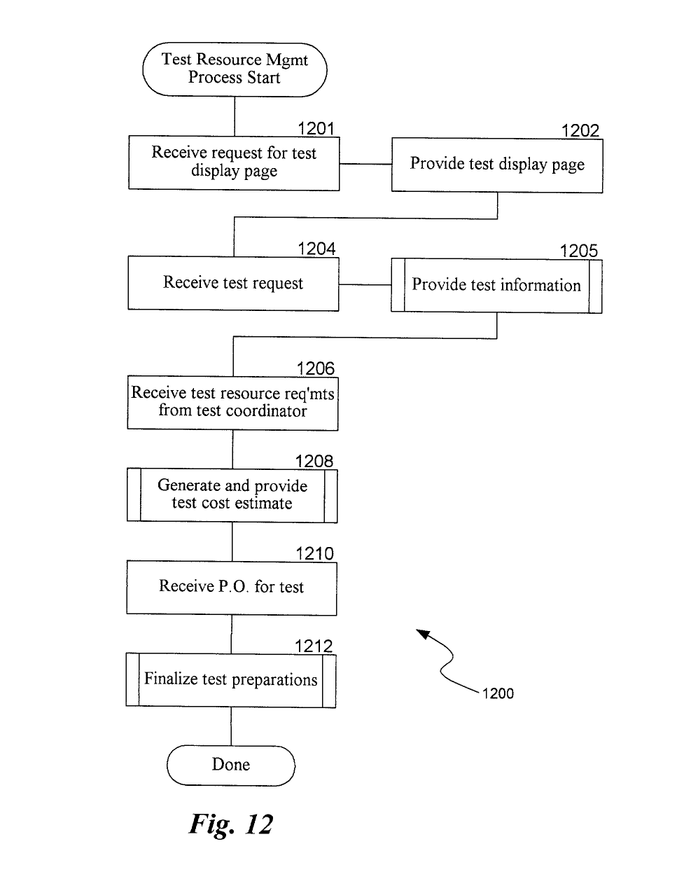

FIG. 12 is a flow diagram illustrating a routine 1200 for managing test resources in one embodiment. In one aspect of this embodiment, the routine 1200 can be used to coordinate an engineering test at a remote location. In another aspect of this embodiment, the routine 1200 can be implemented on a server computer in accordance with computer-readable instructions stored on a computer-readable medium, such as a CD-ROM. In block 1201, the routine 1200 receives a request for a test resource management display page. After providing the requested display page in block 1202, the routine 1200 receives a test request in block 1204. In one aspect of this embodiment, the test request may include background information and parameters for the requested test. In block 1205, the routine 1200 provides at least a portion of the received test request information to a test coordinator.

In block 1206, the routine 1200 receives requirements, such as instrumentation and recording device requirements, for the requested test from the test coordinator. In block 1208, the routine 1200 generates a test cost estimate based on the test resource requirements received. In one aspect of this embodiment, the test cost estimate is then provided to the test requester. In block 1210, the routine 1200 receives an order for the test from the test requester. In another embodiment, the test order represents an agreement to pay the test cost estimate for the test as defined by the test coordinator. After receiving the test order, in block 1212, the routine 1200 finalizes test preparations. After finalizing test preparations, the routine 1200 completes.

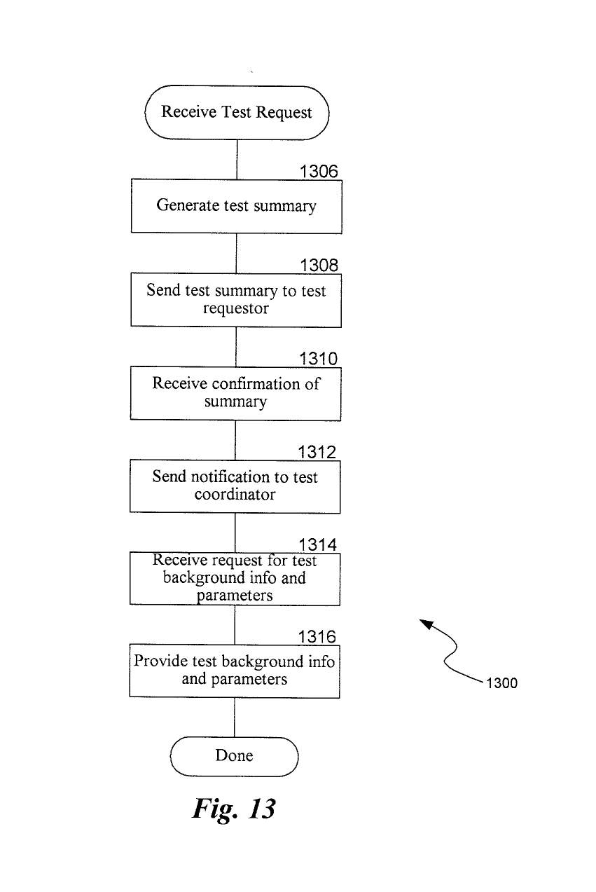

FIG. 13 is a flow diagram illustrating a routine 1300 for providing test request information in one embodiment. In one aspect of this embodiment, the routine 1300 begins when a test request is received. In another aspect of this embodiment, the test request may include background information and parameters for the requested test. In block 1306, the routine 1300 generates a summary of the requested test based on the background information and parameters received. In block 1308, the test summary is electronically transmitted, for example via a communications link such as the Internet, to the test requester for the test requester to review. In block 1310, the routine 1300 receives a confirmation of the test summary from the test requester.

After receiving the confirmation, in block 1312, the routine 1300 transmits an electronic notification, such as an email message, to the test coordinator indicating that a test has been requested and providing a link to the test background information and test parameters. In block 1314, the routine 1300 accordingly receives a request from the test coordinator for the test background information and test parameters. In response to this request, in block 1316, the routine 1300 provides the requested information and parameters to the test coordinator, and the routine 1300 completes.

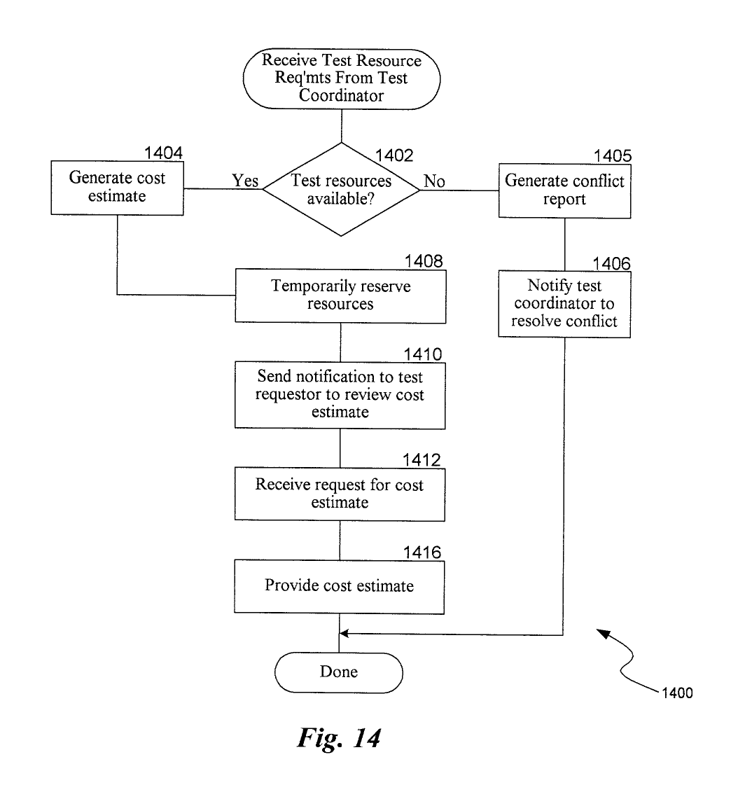

FIG. 14 is a flow diagram illustrating a routine 1400 for generating and providing a test cost estimate in one embodiment. After receiving test resource requirements from a user, such as the test coordinator, in decision block 1402, the routine 1400 determines if the required resources are available. If not, then in block 1405, the routine 1400 generates a conflict report. The conflict report can identify which resources are unavailable and provide an explanation. In block 1406, the routine 1400 sends an electronic notification, for example by email, to the test coordinator notifying the test coordinator that the requested sources are not available and that the test coordinator should take steps to resolve the conflict. In one embodiment, this notification can include the conflict report. After the test coordinator has been so notified, the routine 1400 completes. If, however, the required test resources are available, then in block 1404, the routine 1400 generates a cost estimate for the required resources. In block 1408, the routine 1400 temporarily reserves the test resources. As explained above, the resources can be temporarily reserved pending an order for the test from the test requester.

In block 1410, the routine 1400 sends an electronic notification, for example by email, to the test requester notifying the test requester that a cost estimate for the test has been prepared and the test requester should review the estimate. In block 1412, the routine 1400 receives a request from the test requester for the test cost estimate. After the routine 1400 provides the test requester with the cost estimate in block 1416, the routine 1400 completes.

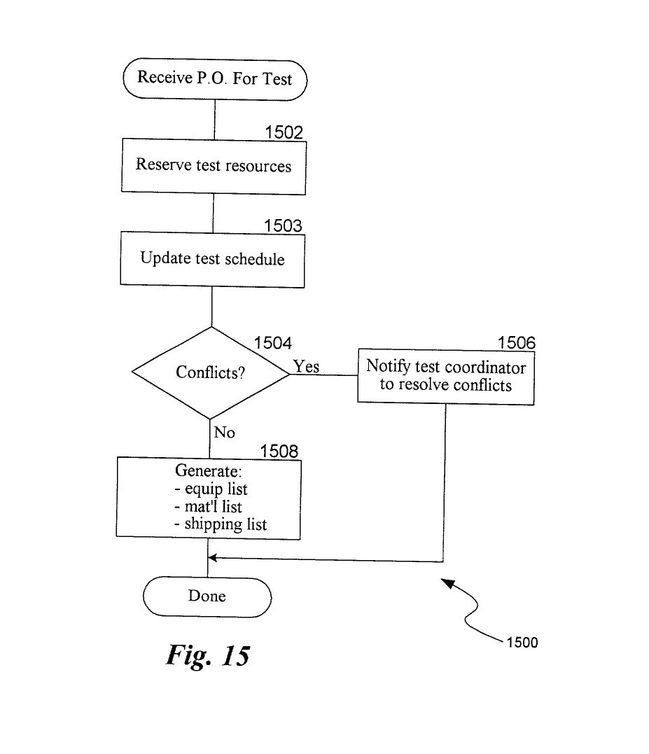

FIG. 15 is a flow diagram illustrating a routine 1500 for finalizing test preparations in one embodiment. In block 1502, after the routine 1500 receives an order for the test from a user, such as a test requester, the routine permanently reserves the required test resources. In one aspect of this embodiment, the test resources are reserved by blocking out appropriate time periods for performance of the test on usage charts corresponding to the particular resources. In block 1503, the routine 1500 schedules the test. Test schedules for all the required test resources, including personnel, instrumentation, and recording and display devices, can be stored in suitable databases. In decision block 1504, the routine 1500 determines if any schedule conflicts exist for the required test resources. If a conflict exists, then in block 1506, the routine 1500 notifies the test coordinator of the conflict and the routine 1500 completes. If no schedule conflict exists, then in block 1508, the routine 1500 makes the final test preparations. In one embodiment, these final preparations can include generating an equipment list, a materials list, and a shipping list for shipment of the equipment and materials to the test site. After the final preparations have been made, the routine 1500 completes.

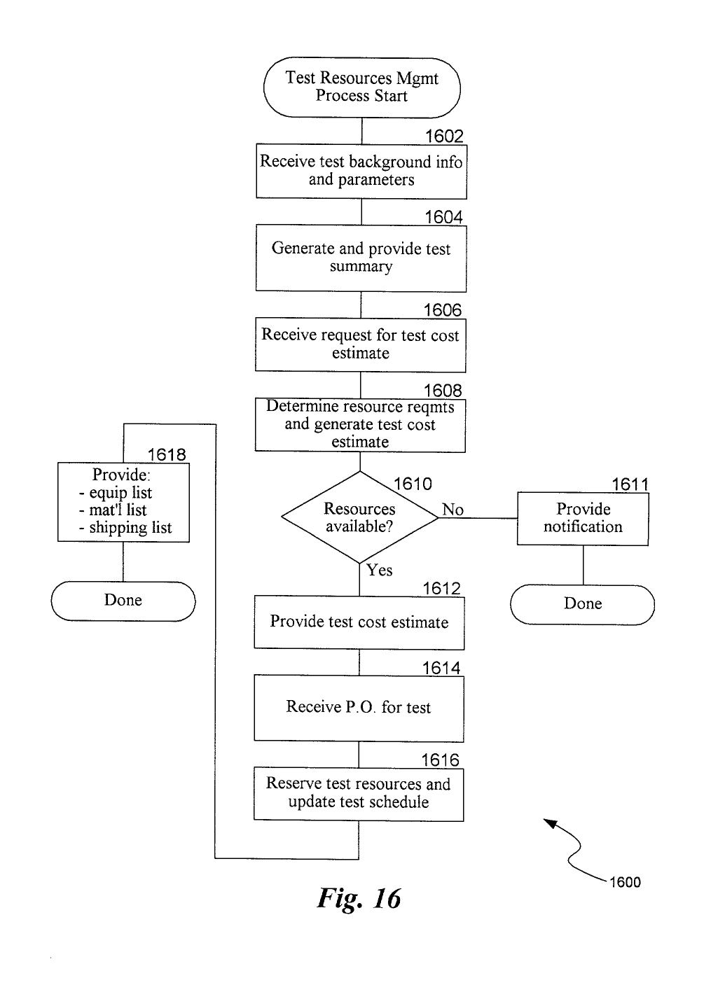

FIG. 16 is a flow diagram illustrating a routine 1600 for managing test resources in accordance with another embodiment. In one aspect of this embodiment, the routine 1600 is implemented on a server computer in accordance with computer-executable instructions stored on a computer-readable medium. In another aspect of this embodiment, the routine 1600 can be substantially similar to one or more of the routines or processes described above. The routine 1600 may differ from the routines and processes described above, however, in that one or more of the steps performed by various users, such as the test requester or the test coordinator, in the routines and processes described above may be performed by the server computer in the routine 1600.

In block 1602, the routine 1600 receives test information, such as background information and parameters, related to a particular test. In block 1604, the routine 1600 generates and provides a test summary based on the test information received. In block 1606, the routine 1600 receives a request for a cost estimate for the test in response to the provided test summary. In block 1608, the routine 1600 determines test resource requirements and generates a test cost estimate based on the resource requirements. In decision block 1610, the routine 1600 determines the availability of the required test resources. If one or more of the required resources are not available, then in block 1611, the routine 1600 provides an electronic notification, for example by email, of this unavailability to a user, such as a test requester or a test coordinator, and the routine 1600 completes. If all the required resources are available, then in block 1612, the routine 1600 provides the test cost estimate to the user, such as the test requester.

In block 1614, the routine 1600 receives an order for the test from a user, such as the test requester, based on the test cost estimate provided. In block 1616, the routine 1600 reserves the required test resources and schedules the test accordingly. In block 1618, the routine finalizes test preparations. Such preparations can include generating and providing an equipment list, a materials list, and a shipping list. After providing these lists to corresponding test personnel for execution or otherwise implementing them, the routine 1600 completes.

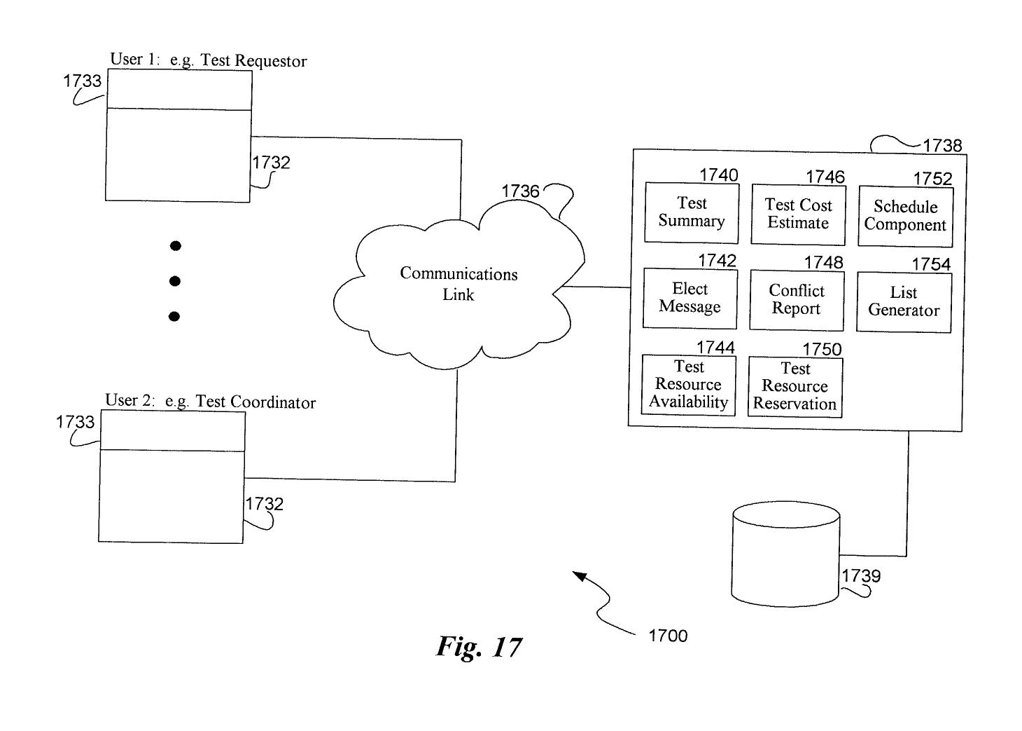

FIG. 17 is a block diagram illustrating components of a test resource management system 1700 in one embodiment. User computers 1732 are connected to a server computer 1738 via a communications link 1736. In one aspect of this embodiment, the communications link 1736 is a computer network, such as a local area network (LAN), an intranet, or the Internet. The user computers 1732 may include a central processing unit, memory devices, input devices (e.g., keyboard and pointing device), output devices (e.g., display devices), and storage devices (e.g., disk drives). The memory and storage devices are computer-readable media that may contain computer instructions for implementing methods and systems, such as routines and display pages, in accordance with this disclosure. The user computers 1732 may also include a browser module 1733 that allows a user to access and exchange data with the communications link 1736, including web sites within the World Wide Web portion of the Internet. In one aspect of this embodiment, the user computers 1732 may be operated by various users of the test resource management system, such as test requesters and test coordinators.

In one embodiment, the server computer 1738 is connected to a resource database 1739 and includes a test summary component 1740, an electronic message component 1742, a resource availability component 1744, a cost estimating component 1746, a conflict report component 1748, a resource reservation component 1750, a test scheduling component 1752, and a resource list component 1754. The test summary component 1740 generates test summaries based on received test information and coordinates the sending of test summaries to users. The electronic message component 1742 coordinates the receiving and sending of electronic mail messages, such as email messages notifying a test coordinator of a requested test. The resource availability component 1744 coordinates searching of the resource database 1739 to determine availability of resources. The cost estimating component 1746 receives test resource requirements and, accordingly, calculates resource costs using preselected valuations for the respective resources. The conflict report component 1748 coordinates the preparation and sending of conflict reports, such as resource scheduling and resource availability conflict reports, to users such as test coordinators. The resource reservation component 1750 controls the reservation of the various test resources contained in the resource database 1739. The test scheduling component 1752 coordinates the scheduling of tests that use the various test resources stored in the resource database 1739. The resource list component 1754 generates lists, such as equipment lists that identify selected test resources, for the various tests.

It will be appreciated from the foregoing that, although specific embodiments of the test resource management system have been described above for purposes of illustration, various modifications may be made without deviation from the spirit or scope of the invention. Further, although the methods and systems have been described in the context of engineering tests on large-scale industrial equipment, it will be understood that the methods and systems are equally well suited for other types of tests on other types of equipment. Those of ordinary skill in the relevant art will appreciate that these and other changes can be made to the invention in light of the above-detailed description.

While certain aspects of the invention are presented below in certain claim forms, the inventors nevertheless contemplate various embodiments of the invention consistent with other claim forms. Accordingly, the inventors reserve the right to add additional claims after filing the application to pursue such additional claim forms for all aspects of the invention. Further, the terms used in the following claims should not be construed to limit the invention to the specific embodiments disclosed in the specification or the claims, but should be construed to include all test resource management systems that operate in accordance with the claims to facilitate testing. The invention is therefore not limited by this disclosure, but instead, the scope of the invention is to be determined entirely by the following claims.

We claim:

1. A method in a computer system for managing test resources, the method comprising:
receiving a request for a test information display page from a first user;
in response to the received request, automatically providing the test information display page to the first user, the test information display page being configured to receive selected test information;
receiving the selected test information;
in response to the received selected test information, automatically providing at least a portion of the received selected test information to a second user;
receiving test resource information related to test resources from the second user in response to the provided portion of the received selected test information; and
in response to the received test resource information, automatically generating a report comprising at least a portion of the received test resource information.

2. The method of claim 1 wherein the report includes a cost estimate associated with the received test resource information, and wherein the method further comprises providing at least a portion of the generated report to the first user.

3. The method of claim 1 wherein the report includes a cost estimate associated with the received test resource information, and wherein the method further comprises:
providing at least a portion of the generated report to the first user;
receiving an order for the test from the first user; and
in response to the received order, reserving at least a portion of the test resources.

4. The method of claim 1 wherein the selected test information includes information related to a test parameter.

5. The method of claim 1 wherein the selected test information includes information related to at least one of:
a test requester;
a test site;
a test date; and
equipment to be tested.

6. The method of claim 1 wherein the test resource information includes information related to at least one of:
test instrumentation; and
a recording device.

7. A method in a computer system for managing test resources, the method comprising:
receiving test information related to a test from a first user;
in response to the received test information, providing at least a portion of the received test information to a second user;
receiving resource information related to test resources from the second user; and
in response to the received resource information, providing at least a portion of the received resource information to the first user.

8. The method of claim 7 further comprising reserving at least a portion of the test resources for a selected period of time.

9. The method of claim 7 further comprising identifying at least a portion of the test resources for use in the test.

10. The method of claim 7 wherein the test information includes information related to a test parameter.

11. The method of claim 7 wherein the test information includes information related to at least one of:
a test requester;
a test site;
a test date; and
equipment to be tested.

12. The method of claim 7 wherein the resource information includes information related to at least one of:
test instrumentation; and
a recording device.

13. The method of claim 7, further comprising generating a report comprising at least a portion of the received resource information, wherein providing at least a portion of the received resource information to the first user includes providing the generated report.

14. A method for coordinating a test, the method comprising:
receiving a request related to a test from a first party;
in response to the received request, providing a test information page to the first party, the test information page configured to receive selected test information;
receiving the selected test information;
in response to the received selected test information, providing at least a portion of the received selected test information to a second party;
receiving test resource information related to test resources from the second party;
in response to the received test resource information, generating a cost estimate based on at least a portion of the received test resource information; and
providing at least a portion of the generated cost estimate to the first party.

15. The method of claim 14 further comprising:
receiving an order for the test from the first party; and
in response to the received order, reserving at least a portion of the test resources.

16. The method of claim 14 wherein the selected test information includes information related to a test parameter.

17. The method of claim 14 wherein the selected test information includes information related to at least one of:
a test site;
a test date; and
equipment to be tested.

18. The method of claim 14 wherein the test resource information includes information related to at least one of:
test instrumentation; and
a recording device.

19. A computer-readable medium containing a display page for collecting information related to a test, the display page comprising:
a test requester portion containing one or more fields for receiving information associated with a test requester;
a test details portion containing one or more fields for receiving information associated with the test; and
a site details portion containing one or more fields for receiving information associated with a site for the test.

20. The computer-readable medium of claim 19 wherein the test requester portion comprises:
a name field for receiving a name of a person requesting the test; and
an address field for receiving an address for the person requesting the test.

21. The computer-readable medium of claim 19 wherein the test requester portion comprises:
a name field for receiving a name of a person requesting the test; and
an email address field for receiving an email address for the person requesting the test.

22. The computer-readable medium of claim 19 wherein the test details portion comprises:
a date field for receiving a date associated with the test; and
an equipment field for identifying equipment to be tested during the test.

23. The computer-readable medium of claim 19 wherein the site details portion comprises:
a site field for receiving an identifier for the site for the test;
a country field for receiving an identifier for a country associated with the site for the test; and
a city field for receiving an identifier for a city associated with the site for the test.

24. The computer-readable medium of claim 19 wherein the display page further comprises a special requirements portion, the special requirements portion containing one or more fields for receiving information associated with special test requirements.

25. The computer-readable medium of claim 24 wherein the special requirements portion comprises a field for receiving an indication that a technical specialist is required for the test.

26. A computer-readable medium containing a display page for collecting information related to parameters of a test, the display page comprising:
a test parameter entry portion, the test parameter entry portion containing a first parameter description field for receiving a description of at least a first test parameter;
an add button; and
a test parameter list portion, the test parameter list portion comprising a second parameter description field for automatically receiving the description of at least the first test parameter when the add button is selected.

27. The computer-readable medium of claim 26 wherein the test parameter entry portion further comprises:
a range field for entering a range associated with the first test parameter; and
an engineering units field for entering units associated with the first test parameter.

28. The computer-readable medium of claim 26 wherein the test parameter entry portion further comprises one or more device fields for indicating a type of measuring device or recording device associated with the first test parameter.

29. The computer-readable medium of claim 26 wherein the test parameter entry portion further comprises one or more of:
a tape recorder field for indicating that a tape recording device is associated with the first test parameter;
a chart recorder field for indicating that a strip-chart recording device is associated with the first test parameter;
a dynamic data acquisition field for indicating that a dynamic data acquisition device is associated with the first test parameter; and
a display field for indicating that a display device is associated with the first test parameter.

30. The computer-readable medium of claim 26 wherein:
the first test parameter is a physical measurement; and
the test parameter entry portion comprises a multiple entries field for indicating that the first test parameter is associated with a plurality of occurrences.

31. The computer-readable medium of claim 26 wherein:
the first test parameter is a physical measurement;
the test parameter entry portion comprises a multiple entries field for indicating that the first test parameter is associated with a plurality of occurrences; and
the test parameter list portion comprises a plurality of parameter description fields for automatically receiving the descriptions of the plurality of test parameter occurrences when the add button is selected.

32. The computer-readable medium of claim 26 wherein the test parameter list portion includes a third parameter description field for automatically receiving a description of a second test parameter when the add button is selected.

33. A computer system for managing test resources, the computer system comprising:
means for receiving test information related to a test from a first user;
means for providing at least a portion of the received test information to a second user in response to the received test information;
means for receiving resource information related to test resources from the second user in response to the provided portion of the received test information; and
means for providing at least a portion of the received resource information to the first user in response to the received resource information.

34. The computer system of claim 33, further comprising means for reserving at least a portion of the test resources for a selected period of time.

35. The computer system of claim 33, further comprising means for identifying at least a portion of the test resources for use in the test.

36. The computer system of claim 33, further comprising means for scheduling the test.

37. The computer system of claim 33, further comprising means for generating a report comprising at least a portion of the received resource information, wherein the means for providing at least a portion of the received resource information to the first user includes means for providing the generated report.

38. A computer-readable medium whose contents cause a computer system to manage test resources, the test resources being managed by a method comprising:
receiving information related to a test from a first user;
in response to the received test information, providing at least a portion of the received test information to a second user;
receiving resource information related to test resources from the second user in response to the provided portion of the received test information; and
in response to the received resource information, providing at least a portion of the received resource information to the first user.

39. The computer-readable medium of claim 38 wherein the method further comprises reserving at least a portion of the test resources for a selected period of time.

40. The computer-readable medium of claim 38 wherein the test information includes information related to at least one of:
a test parameter;
a test requester;
a test site;
a test date; and
equipment to be tested.

41. The computer-readable medium of claim 38 wherein the resource information includes information related to at least one of:
test instrumentation; and
a recording device.

42. The computer-readable medium of claim 38 wherein the method further comprises generating a report comprising at least a portion of the received resource information, wherein providing at least a portion of the received resource information to the first user includes providing the generated report.

43. A method in a computer system for requesting a test, the method comprising:
requesting a test information display page;
receiving the test information display page, the test information display page configured to receive selected test information related to the test;
displaying the test information display page;
receiving the selected test information from a user; and
sending the selected test information to a server computer.

44. The method of claim 43, further comprising:
receiving a test report display page, the test report display page containing selected test resource information related to resources for the test; and
displaying the test report display page.

45. The method of claim 44 wherein the test report display page includes a test cost associated with the test resources and a test request button, wherein selecting the test request button submits an order for the test, and wherein the method further comprises receiving a selection of the test request button from the user.

46. The method of claim 44 wherein the selected test resource information includes information related to at least one of:
test instrumentation; and
a recording device.

47. The method of claim 43 wherein the selected test information includes information related to at least one of:
a test parameter;
a test requester;
a test site;
a test date; and
equipment to be tested.

48. A method in a computer system for generating a test cost estimate, the method comprising:
receiving a notification of a test request, the test request including test information;
in response to the received notification, accessing at least a portion of the test information;
based on the accessed portion of the test information, receiving test resource requirements from a user; and
based on the received test resource requirements, determining a cost estimate.

49. The method of claim 48 wherein the received test resource requirements include requirements related to at least one of:
test instrumentation; and
a recording device.

50. The method of claim 48 wherein the test information includes information related to at least one of:
a test parameter;
a test requester;
a test site;
a test date; and
equipment to be tested.
